(19) United States
(12) Patent Application Publication
(10) Pub. No.: US 2007/0204899 A1
(43) Pub. Date: Sep. 6, 2007

(54) Photovoltaic cell a solar amplification device

(76) Inventor: Darry Lafayette Boyd SR., San Diego, CA (US)

Correspondence Address: Darry L. Boyd sr., 6862 Pear Tree Dr., Carlsbad, CA, 92011, US

(21) Appl. No.: 11/367,170

(22) Filed: Mar. 2, 2006

(51) Int. Cl. H02N 6/00

(52) U.S. Cl. 136/244

(57) ABSTRACT

A system or methods are provided for the overall improvement in efficiency in photovoltaic solar cells. In various embodiments, a variety of the sun wavelength are utilize in a multifunction arrangement to create an amplification process. The wavelength that are normally pass through a typical solar is utilize as bias to create a electro magnetic field or voltage source to accelerate the electron or increase the electron flow out of the solar circuit. A portion of the sun energy is utilized in a secondary circuit to create a power source that is further used to generate an additional power source. This invention relates to a solar amplification process and a device configured with photovoltaic semiconductors.

### BACKGROUND OF THE INVENTION

In a world, which is still dominated by fossil fuels, and will be for many years, more and more people are not only demanding access to energy, but also asking for clean energy. An improved solar power system assists in meeting those individual demands for a safe, reliable and clean form of energy all over the world.

Many more people would switch to using solar energy if the cost of a solar system were lower. This problem relates to the low efficiency that solar cells have at converting sunlight into power. The cost of manufacturing solar cells and the number of cells that are need to power a home or a business is still quite high compare to using conventional fossil fuel.

The sunlight wavelength spectrum can produce up to 1000 watts of energy per square meter when striking the earth surface. The sun provides us with more than enough energy to power a home or business without the mass number of solar cells that are currently needed. Light can be separated into different wavelengths, and we can see them in the form of a rainbow. Since the light that hits a photovoltaic cell has photons of a wide range of energies, it turns out that some of them won't have enough energy to form an electron-hole or current. They'll simply pass through the cell as if it were transparent. Still other photons have too much energy. Only a certain amount of energy measured in electron volts and defined by typical cell material about 1.1 electron volts for crystalline silicon is required to knock an electron loose. We call this the band gap energy of a material. If a photon has more energy than the required amount, then the extra energy is lost unless a photon has twice the required energy, and can create more than one electron-hole pair.

Multi junction cells and multi junction cells with mosfets provide some improvement but are still lest than 30 percent efficiency. They capture some additional energy but it's an added effect not amplification.

In view of these, there exists a need for improved solar cell. This invention relates to technological development of a solar intergraded circuit form to take advantage of more of the solar spectrum and to improve the way electron move in a typical solar cell. Thereby, vastly increase the output of the typical solar power cell beyond 30 percent efficiency.

### BRIEF SUMMARY OF THE INVENTION

The present invention, roughly described, provides an improved photovoltaic (PV) solar energy system. In various embodiments, silicon substrates will be configured and bias to performed solar energy amplification. These solar amplifier circuit when physical and electrically connected together and exposed to light and other electromagnetic wave will greatly increase output power in solar cell per square feet.

In one embodiment method is shown how layers or substrates are biased to achieve current amplification.

In another embodiment method is shown how layers or substrates are configured to achieve current amplification.

In another embodiment method is shown how layers or substrates are configured to use other part of electromagnetic spectrum to achieve current amplification.

In another embodiment, a illustration is provided to show how typical solar power cell of 58 inches long and with a with of 38 inches and power rate of 165 watts. This typical cell size can be converted to have the power output of 2,970 watts.

These as well as other embodiments contemplated by the present invention will be more fully set forth in the detailed description below and the figures submitted herewith.

### BRIEF DESCRIPTION OF THE DRAWINGS

FIG. 1 illustrates a block diagram of the dope semiconductors layers of the photovoltaic circuit in accordance with the present invention.

FIG. 2 illustrates the process performed in response to the incoming sunlight wavelength and other wavelength in accordance with the present invention.

FIG. 3 illustrates the block diagram comparing a typical solar cell to the present invention

### DETAIL DESCRIPTION OF THE INVENTION

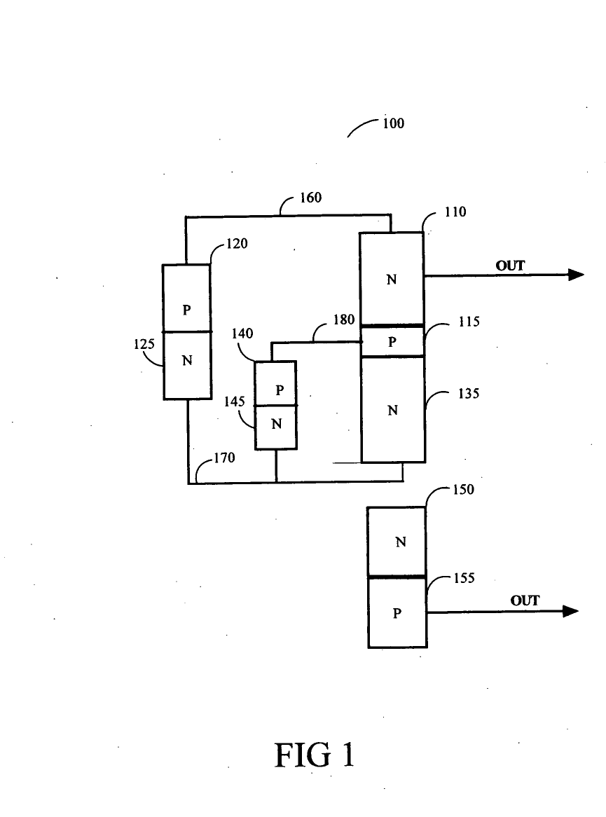

FIG. 1 illustrates the solar cell layer arrangement diagram of a photovoltaic solar amplifier circuit 100 in accordance with an embodiment of the present invention. Through the photovoltaic solar amplifier circuit 100, radiation or wavelength from the sun can produce up to 1000 watts or more of energy per square meter when striking the earth or photovoltaic solar amplifier circuit. The sun emits almost all it energy from a range wavelength from about 200 nanometers to 4000 nanometers

As illustrated in FIG. 1, silicon substrates or layers 115 and 135 are dope with impurities to form a P N junction and is band gapped to absorb wavelength from 900 to 320 nanometers. The proton with this wavelength strikes the semiconductor dope electron and hole layers 110, 115 and 135 creating an electro magnetic field across the junction 115 and 135.

Silicon substrate or layers 120 and 125 are dope and band gapped to absorb wavelength from 200 to 100 nanometers for biasing. This P N junction is use to create a voltage and a magnetic field that will accelerate the electron through the junction of 110 and 115. In a typical solar cell a problem or a loss of efficiency occurred when an electron and hole quickly thermalise or relax back to the edges of the respective carrier bands emitting photons a fundamental particle which, unlike an electron, has low energy but relatively high momentum. The energy thus wasted is dissipated as heat. Excessive recombination of carrier's electron and hole in the semiconductor bulk and at the surfaces reduces efficiency. A major reason for the low efficiency in solar cells is the fact that each photon, irrespective of its high energy, generates one electron hole pair. This present invention solved these problems by creating an electrical charge that accelerates the electron through the junction of 110 and 115.

Silicon substrate or layers 140 and 145 are dope and band gapped to absorb wavelength from 1200 to 1800 nanometers for electrical biasing. This P N junction is use to create a voltage and a magnetic field that will to push the electrons toward the junction of 115 and 135. In a solar cell only the electron hole pair generated near the P N junction contributes to light generated current. The problem is carriers generated well away from the junction have the tendency to recombine before they complete their travel from the point of generation to the solar cell terminal. This present invention solved this problem by creating a charge that pushes the electron toward and through the junction.

To the make the solar amplifier circuit conduct, appreciate current greater than 1 milliamp from 115 to 135, voltage created by junction 140 and 145 must be equal to or greater than the cut off voltage. The cut voltage is between 600 and 700 millivolts. This applied voltage causes substrate or layer 115 junction to turn-on allowing flow of electrons from 135 in to 115. Because of the electric field that is existing between 115 and 110 caused by the voltage generated by layers 120 and 125, the majority of these electrons across the 110 and 115 junctions into the 110 to form the 110 current output. the remainders of the electrons exit the 115 connection to form 115 current. The ratio of 110 current to 115 current is the DC current gain. This gain can be 25 times current in or larger.

Layers 150 and 155 are doped and band gapped P N junction for wavelength absorb wavelength 2000 to 2500 nanometers for a voltage peaking circuit or charging a battery for night operation.

Connections 160, 170 and 180 are set to the necessary resistance to create the proper bias.

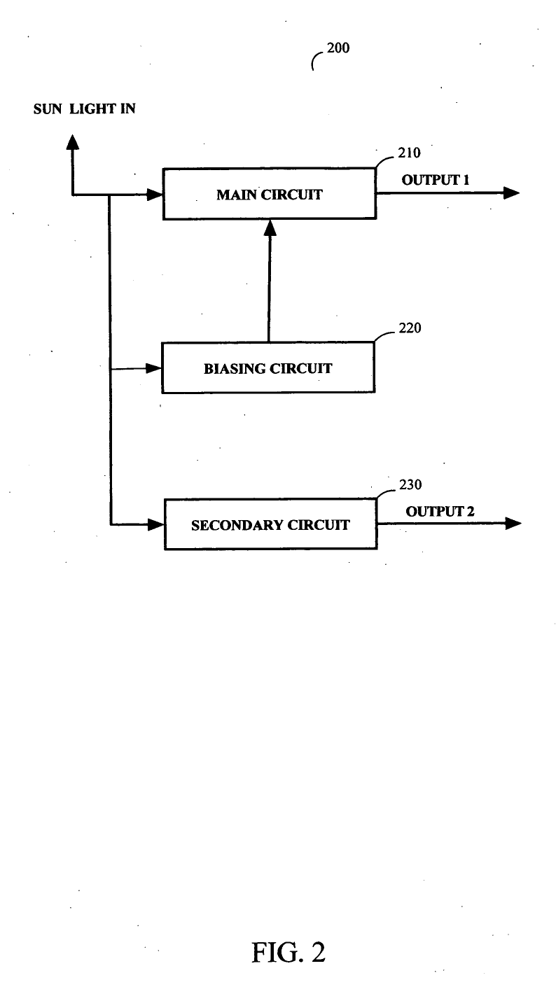

FIG. 2 illustrates the process performed in response to the incoming sunlight wavelength 200 in accordance with this present invention. This invention utilizes an array of solar bias power 220 in between layers to generate greater current flow in electron flow in main circuit 210. The bias layers are adequately dope and band gap to utilize different range of the wavelength that sun provides creating the necessary voltage levels to perform amplification through the main circuit 210. The secondary circuit, 230 is layered, doped and band gapped to generate addition current movement.

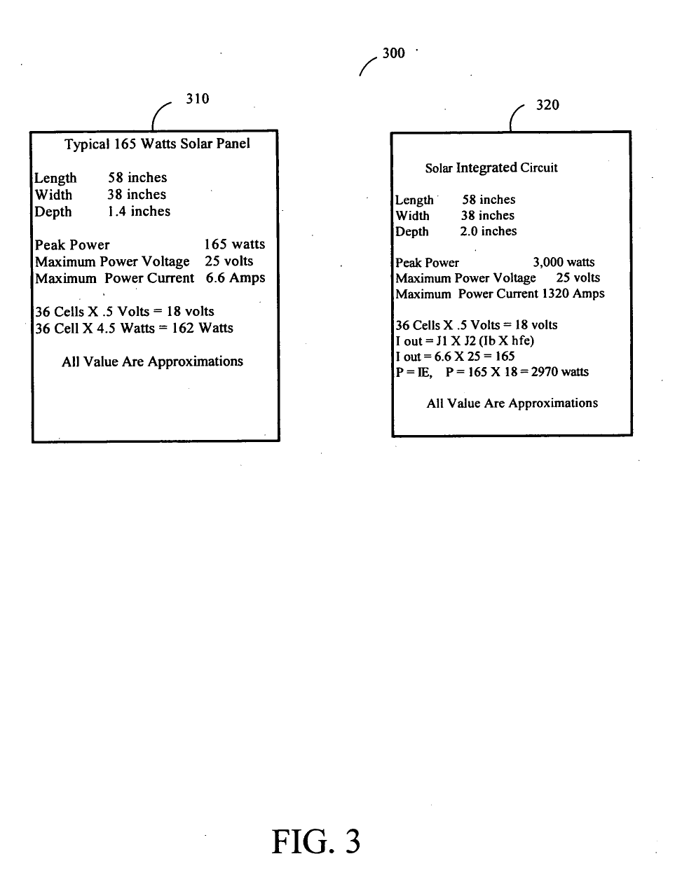

FIG. 3 illustrates a block diagram 300 comparing a typical solar cell 310 to this present invention 320.

I claim

1. A method for power amplification of photovoltaic generated source, the method comprising:
detecting incoming sunlight wavelength by the photovoltaic device;
converting the solar wavelength format to power format that can be amplified;
and transmitted the signal within the photovoltaic device.

2. The method or process of voltage biasing photovoltaic device semiconductor junctions to create electromagnetic fields to accelerate the movement of electron hole pair for power amplification.

3. A method of claim 2, photovoltaic semiconductor biasing device is a photovoltaic device using incoming sunlight.

4. A method of biasing the photovoltaic device with a photovoltaic device to achieve power amplification out to the connected load.

5. A method of using multi parts of the sun wavelength band to achieve power amplification in a photovoltaic device.

6. A method of using numerous photovoltaic band gaps and doping to achieve power amplification in a photovoltaic device.

7. A method of using power amplification to convert sun wavelength to electromagnetic charge semiconductor junctions to accelerate the movement of electron hole pairs without an external physical device, source or signal.
